(19) United States
(12) Patent Application Publication
(10) Pub. No.: US 2024/0378678 A1
(43) Pub. Date: Nov. 14, 2024

(54) SYSTEMS AND METHODS FOR GENERATING USER OFFERINGS RESPONSIVE TO TELEMATICS DATA

(71) Applicant: State Farm Mutual Automobile Insurance Company, Bloomington, IL (US)

(72) Inventors: Kimberly C. Kloeppel, Mesa, AZ (US); Anthony Welcome, Mesa, AZ (US)

(21) Appl. No.: 18/637,863

(22) Filed: Apr. 17, 2024

Related U.S. Application Data
(60) Provisional application No. 63/501,846, filed on May 12, 2023.

(51) Int. Cl. G06Q 40/08; B60W 40/09; H04L 67/55

(52) U.S. Cl. CPC G06Q 40/08; B60W 40/09; H04L 67/55

(57) ABSTRACT

A user analytics computing device for processing mobile device telematics data and generating user offerings responsive to the mobile device telematics data is provided. The user analytics computing device comprises at least one processor programmed to generate an operator model for a user based upon historical telematics data, an output of the operator model to determine whether the user is operating a vehicle. The user analytics computing device is further programmed to input telematics data into the operator model, and in response to determining the user is operating the vehicle, generate a driver profile based upon the telematics data and the device mode data, generate, based upon the driver profile, a user offering, and transmit, to the mobile device of the user, the user offering.

### CROSS-REFERENCE TO RELATED APPLICATIONS

This application claims the benefit of priority to U.S. Provisional Patent Application No. 63/501,846 filed on May 12, 2023, entitled “SYSTEMS AND METHODS FOR GENERATING USER OFFERINGS RESPONSIVE TO TELEMATICS DATA,” the entire contents and disclosures of which are hereby incorporated by reference herein in their entirety.

### FIELD OF THE DISCLOSURE

The present disclosure generally relates to analyzing processing telematics data, and, more particularly, to systems and methods for generating user offerings responsive to telematics data, including vehicle-based and nonvehicle-based telematics data.

### BACKGROUND

Vehicle collisions due to driving behavior such as distracted driving are widespread. For example, many vehicle accidents may occur due to drivers being distracted (e.g., texting, talking on the phone). Poor driving behavior (e.g., distracted driving) places other drivers at risk every day. For example, a safe driver operating a brand-new vehicle may be involved in an accident due to a distracted driver of another vehicle. Vehicle accidents may be costly, time consuming, and in serious cases, fatal.

Although many vehicles include safety features designed to prevent collisions, these systems may be generally based upon monitoring the vehicle operator's own driving behavior (e.g., lane departure warning and lane-keeping assist systems). Some safety features may be used or deployed when a vehicle accident occurs (e.g., airbags, inflatable seat belts). Furthermore, vehicles possessing autonomous or semi-autonomous technology or functionality may reduce the risk of vehicle accidents due to an operator's own driving behavior. However, these vehicles may be susceptible to causing accidents due to vehicle malfunction (e.g., engine software problems). Conventional techniques may include additional drawbacks, ineffectiveness, encumbrances, and inefficiencies as well.

### BRIEF SUMMARY

The present embodiments relate to, inter alia, computer-based systems and methods that include a monitoring system configured to determine whether one or more conditions are present, and disincentivizes conditions conducive to distracted driving.

In one aspect, a user analytics computing device for processing vehicle-based telematics data and generating user offerings responsive to the vehicle-based telematics data may be provided. The user analytics computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the user analytics computing device may include at least one processor (and/or associated transceiver) in communication with a memory device. The at least one processor and/or associated transceiver may be programmed to: (1) generate an operator model for a user based upon historical telematics data, an output of the operator model to determine whether the user is operating a vehicle; (2) receive, from a mobile device of the user, telematics data associated with movement of the user over a period of time and mobile device mode data over the period of time; (3) input the telematics data into the operator model, and in response to determining the user is operating the vehicle, generate a driver profile based upon the telematics data and the device mode data; (4) generate, based upon the driver profile, a user offering; and/or (5) transmit, to the mobile device of the user, the user offering. The user analytics computing device may include additional, less, or alternate functionality, including that discussed elsewhere herein.

In another aspect, a computer-implemented method for processing vehicle-based telematics data and generating user offerings responsive to the vehicle-based telematics data may be provided. The computer-implemented method may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the method may be implemented by a user analytics computing device including at least one processor in communication with a memory device. The method may include, via the processor: (1) generating an operator model for a user based upon historical telematics data, an output of the operator model to determine whether the user is operating a vehicle; (2) receiving, from a mobile device of the user, telematics data associated with movement of the user over a period of time and mobile device mode data over the period of time; (3) inputting the telematics data into the operator model, and in response to determining the user is operating the vehicle, generate a driver profile based upon the telematics data and the device mode data; (4) generating, based upon the driver profile, a user offering; and/or (5) transmitting, to the mobile device of the user, the user offering. The method may include additional, less, or alternate functionality, including those discussed elsewhere herein.

In a further aspect, a non-transitory computer-readable storage medium having computer-executable instructions embodied thereon may be provided. The computer-executable instructions may be executed using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, when executed by a user analytics computing device having at least one processor in communication with at least one memory, the computer-executable instructions may cause the at least one processor and/or associated transceiver to: generate an operator model for a user based upon historical telematics data, an output of the operator model to determine whether the user is operating a vehicle; receive, from a mobile device of the user, telematics data associated with movement of the user over a period of time and mobile device mode data over the period of time; input the telematics data into the operator model, and in response to determining the user is operating the vehicle, generate a driver profile based upon the telematics data and the device mode data; generate, based upon the driver profile, a user offering; and transmit, to the mobile device of the user, the user offering. The user analytics computing device may include additional, less, or alternate functionality, including that discussed elsewhere herein. The storage medium may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary computer system including a user analytics computing device in accordance with the present disclosure.

FIG. 2 illustrates a schematic diagram of an exemplary user analytics computing device that may be used in the computer system shown in FIG. 1.

FIG. 3 illustrates a first example user interface in accordance with an exemplary embodiment of the present disclosure.

FIG. 4 illustrates a second example user interface in accordance with an exemplary embodiment of the present disclosure.

FIG. 5 illustrates an exemplary client computing device that may be used with the exemplary computer system illustrated in FIG. 1.

FIG. 6 illustrates a diagram of components of one or more exemplary computing devices that may be used in the exemplary computer system shown in FIG. 1.

FIG. 7 illustrates a flow chart of an exemplary computer-implemented process that may be carried out by the exemplary computer system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, computer-based systems and methods for monitoring and collecting telematics data, and generating user offerings responsive to the telematics data. For example, in some embodiments, a user analytics computing device is configured to generate an operator model for a user that is generated and trained based upon historical telematics data. An output from the operator model is generated to indicate whether the user is operating a vehicle. When the telematics data is received from a mobile device of a user which indicates that the user is travelling in a vehicle, the user analytics computing device inputs the telematics data, sensor data and/or other additional data, into the operator model to determine whether the user is the one operating the vehicle. The user analytics computing device tracks whether the user's mobile phone is in a “do not disturb” (DND) mode for the duration of the trip. If it is determined that the user is operating the vehicle, the user analytics computing device is configured to generate a driver profile based upon the telematics data and the DND mode data. The user analytics computing device is further configured to generate a user offering, such as an incentive or discount, based upon the telematics data and the DND mode data, and transmit the user offering to the mobile device of the user. The user analytics computing device may include additional, less, or alternate functionality, including that discussed elsewhere herein.

“Vehicle,” as used herein, may refer generally to any vehicle owned, operated, and/or used by one or more vehicle users. A vehicle may include any kind of vehicle, such as, for example, cars, trucks, all-terrain vehicles (ATVs), motorcycles, recreational vehicles (RVs), snowmobiles, boats, autonomous vehicles, semi-autonomous vehicles, user-driven or user-operated vehicles, industrial vehicles (e.g., construction vehicles), “riding” lawnmowers, farm equipment, planes, helicopters, bicycles, flying cars, robo-taxis, self-driving taxis, and/or any kind of land-, water-, or air-based vehicle.

“Vehicle user,” as used herein, may refer generally to a person who is responsible for the vehicle, and who has access to use of the vehicle. Vehicle users may include owners, lessors, and/or renters, for example, of a vehicle. Vehicle users may be personal vehicle users (e.g., may be responsible for and have access to one or more vehicles for personal use) and/or may be corporate vehicle users (e.g., corporate managers who may be responsible for and have access to one or more vehicles associated with corporate use and/or with a corporate entity).

“App,” as used herein, may refer generally to a software application installed and downloaded on a user computing device and executed to provide an interactive graphical user interface at the user computing device. An app associated with the computer system, as described herein, may be understood to be maintained by the computer system and/or one or more components thereof. Accordingly, a “maintaining party” of the app may be understood to be responsible for any functionality of the app and may be considered to instruct other parties/components to perform such functions via the app.

“Telematics data,” as used herein, may refer generally to data associated with monitoring a moving computing device. Telematics data incorporates location, movement (e.g., speed, direction, acceleration, etc.), and condition (e.g., “on”, “off”, in-motion, etc.) data based upon a plurality of sensors on-board the computing device and/or connected to the computing device. Accordingly, where the computing device is associated with a vehicle, the telematics data may be associated with monitoring the vehicle. Where the computing device is a personal mobile computing device, such as a smart phone, the telematics data may be associated with monitoring the personal mobile computing device. In at least some cases, the personal mobile computing device may be used to capture vehicle telematics data, where the personal mobile computing device is present in/on a vehicle during motion/use of the vehicle.

“Sensor data,” as used herein, may refer generally to data captured by sensors that is not necessarily associated with the movement of a computing device. For example, sensor data for a vehicle may include data that captures movement of occupants of the vehicle, which may not affect the motion of the vehicle. In some cases, telematics data may include sensor data, where data is sent in packets that include data from all sensors associated with a computing device (e.g., both motion and non-motion sensor data).

In the exemplary embodiment, a computer system is configured to leverage telematics data to generate user offerings in response to a user's driving behavior over time with respect to the mode of their mobile device as indicated in the telematics data. The telematics data may be received from one or more sources, including a user's mobile device. More particularly, the computer system uses telematics data to determine whether a user is driving on a trip and whether the user's mobile phone was in a DND mode during all or a portion of the trip. In some embodiments, a user may agree to allow user analytics app to access their mobile device's DND mode data. For example, in some embodiments, the user analytics app causes to be displayed on a user interface of the user's mobile device, a notification requesting the user grant the data management software access to the mobile devices DND mode data.

The computer system may receive and analyze additional data, such as sensor data, to make certain determinations, such as whether the user is in the driver's seat and therefore is the driver. In the exemplary embodiment, the computer system may capture and synthesize this data, leveraging machine learning and/or artificial intelligence tools, to generate and provide user offerings that may save a user money, reduce a user's risk, provide incentives and rewards, and the like. In some embodiments, the computer system may receive, retrieve, capture, and/or otherwise access telematics data, sensor data, and/or additional or alternative data from a user's mobile device and/or one or more third-party or external sources. For example, the computer system may receive confirmation from the user computing device whether or not the user is the driver during a trip. The computer system may include any suitable data storage capabilities, such as cloud storage, to access and/or store any of the above data. In that way, the computer system may access and analyze historical and/or current (e.g., real-time or near real-time) data. In some embodiments, the computer system may include or be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another.

In the exemplary embodiment, the computer system includes at least one user analytics computing device. The user analytics computing device is configured to perform the functions that may be more generally described herein as being performed by and/or attributed to the overall computer system.

In particular, in the exemplary embodiment, the user analytics computing device may be in communication with one or more computing devices associated with a user. These computing devices may include a personal mobile computing device, such as a smart phone, tablet, and the like. These computing devices may additionally or alternatively include a vehicle computing device associated with a personal vehicle of the user (e.g., a vehicle that the user drives or operates, which may be a non-autonomous, semi-autonomous, and/or autonomous vehicle). A vehicle computing device may include a computing device integral to the vehicle and/or a personal mobile computing device that is in, on, or otherwise associated with the vehicle while the vehicle is operating.

The user analytics computing device may receive data from the computing device(s), including telematics data associated with motion of the user, sensor data, and/or any other type of data. The user analytics computing device may receive portions of such data from alternative computing devices, such as third-party computing devices. Additionally, or alternatively, the user analytics computing device may access portions of such data from one or more databases or other memory devices. That is, the user analytics computing device need not receive data in “real-time” in order to perform the methods described herein, but may receive data in “real-time.”

The user analytics computing device may be configured to aggregate, combine, synthesize, parse, compare, and/or otherwise process this data, as described in more detail herein, in order to (i) determine whether a user is driving during a trip; (i) determine whether the user's mobile device was in do not disturb (DND) mode during all or a portion of the trip, (iii) collect DND mode data during user travel for a time period, (iv) build one or more profiles reflective of user behavior, such as traveling DND mode data, and/or (v) generate user offerings based upon those profile, where the user offerings are designed to influence and/or affect future user behavior, which may, in turn, influence and/or affect the profiles.

The user analytics computing device may store any received, retrieved, and/or accessed data in one or more databases, and may store any profiles, user offerings, and/or other generated data in the one or more databases. A database may be any suitable storage location, and may in some embodiments include a cloud storage device such that the database may be accessed by a plurality of computing devices (e.g., a plurality of user analytics computing devices, insurance computing devices, third-party computing devices, etc.). The database may be integral to the user analytics computing device or may be remotely located with respect thereto.

As used herein, a user's profile is a summary, aggregation, and/or general description of a mode of a user's mobile device while driving. More particularly, the user's profile may comprise a summary of how often a user's mobile device is in DND mode while driving. The user analytics computing device may develop or generate the user's profile over time, based upon telematics data associated with one or more trips the user has taken in which the user was the driver. The profile may include average values, maximum values, minimum values, weight averages, median values, ranges, and other quantitative measures of the mode of the user's mobile device while driving.

Based upon the user's profile, the user analytics computing device may generate one or more user offerings. In some embodiments, the one or more offerings may comprise a reduction in the user's insurance premium or an associated discount. Accordingly, the user may both reduce their overall risk (e.g., by reducing distracted driving) and save money (e.g., by reducing their insurance costs).

In some embodiments, the user analytics computing device generates the user offering based upon historical data, that is, based upon the user's past behavior. In some such embodiments, the user analytics computing device may transmit the user offering to the user once, for example, in response to determining that the user is eligible for the user offering (e.g., based upon the user's profile). In some embodiments, the eligibility for a user offering is based upon a percentage of time the user has driven with their mobile device in DND mode over a certain time period (e.g., over the course of the past week, month, or year).

For example, in some embodiments the user analytics computer device a user offering may comprise an insurance discount which correlates to the percentage of time the user has driven with their mobile device in DND mode. For another example, if the user drove with their mobile device in DND mode 80% of the time over the past month, the user analytics computing device may transmit a user offering of a 20% insurance discount for the next month; if the user drove with their mobile device in DND mode 70% of the time over the past month, the user analytics computing device may transmit a user offering of a 10% insurance discount for the next month; if the user drove with their mobile device in DND mode 60% of the time, the user analytics computing device may transmit a user offering of a 5% insurance discount for the next month. These numerical figures are provided by way of example only, and various other discounts may be generated based upon the user's distraction profile data.

In some embodiments, the user offering is transmitted to an insurance server which automatically applies the discount. Additionally, or alternatively, the user offering may receive a numerical code, a QR code, a barcode, or the like, which the user can use to manually apply a discount.

Data such as the user's total driving minutes, the user's driving minutes with their phone in DND mode, the percentage of time the user has driven with their mobile device in DND mode may be collected over time and used to build the user's distraction profile. The user analytics computing device may transmit the user offering to the user within the user analytics app. Additionally, or alternatively, the user analytics computing device transmits the user offering to the user as a pop-up or push-notification, through a text message, e-mail, and/or the like. The user offering may be presented to the user as a report or document that includes the notification.

In some embodiments, the user analytics computing device determines one or more conditions which prompt the user analytics computing device to send one or more messages to the user's mobile device. For example, in response to the user analytics computing device determine the user's mobile device is within a distance of the vehicle (e.g., using a wireless beacon location within the vehicle, GPS, and the like), the user analytics computing device may send a pop-up or push notification to the user's computing device, such as “Would you like to turn Do Not Disturb mode on?” in order to remind a user to turn on a DND mode before driving. In some embodiments, the message may further comprise a toggle in which a user can switch the mobile device to DND mode.

The technical effect of the systems and processes described herein may be achieved by performing at least one of the following steps: (i) generating an operator model for a user based upon historical telematics data, an output of the operator model to determine whether the user is operating a vehicle; (ii) receiving, from a mobile device of the user, telematics data associated with movement of the user over a period of time and mobile device mode data over the period of time; (iii) inputting the telematics data into the operator model; (iv) in response to determining the user is operating the vehicle, generating a driver profile based upon the telematics data and the device mode data; (v) generating, based upon the driver profile, a user offering; and/or (vi) transmitting, to the mobile device of the user, the user offering.

The resulting technical effects may include, for example: (i) encouraging safer driver or risk averse behavior based upon incentives; (ii) reducing the cost of providing insurance products to drivers; (iii) enhancing driver and user profiles by incorporating mobile device mode data; (iv) receiving data from a plurality of data sources to better predict a driving distraction status; and/or (v) increased quantitative analysis of driving data to enhance driving safety.

### Exemplary Computer System for Generating User Offerings Responsive to User Telematics Data

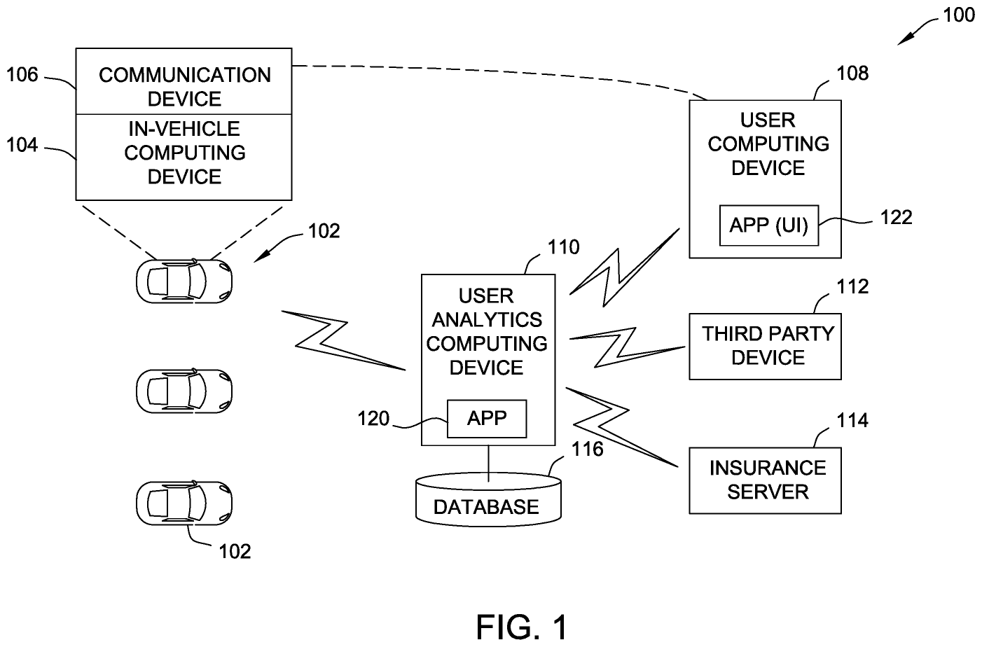

FIG. 1 depicts a schematic diagram of an exemplary computer system 100. Computer system 100 is configured to generate dynamic and intelligent user offerings responsive to user telematics data. In one exemplary embodiment, computer system 100 may include and/or facilitate communication between a vehicle 102 (e.g., via an in-vehicle computing device 104 and/or communication device 106), one or more user computing devices 108 (which may also be referred to as “mobile devices”), and a user analytics computing device 110, and/or between user analytics computing device 110 and one or more of third-party devices 112 and/or insurance servers 114.

User analytics computing device 110 may be implemented as a server computing device with artificial intelligence and deep learning functionality. Alternatively, user analytics computing device 110 (and/or user computing devices 108) may be implemented as any device capable of interconnecting to the Internet, including mobile computing device or “mobile device,” such as a smartphone, a “phablet,” or other web-connectable equipment or mobile devices (such as one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another).

User analytics computing device 110 may be in communication with vehicles 102, one or more user computing devices 108, third party devices 112, and/or insurance servers 114, such as via wireless communication or data transmission over one or more radio frequency links or wireless communication channels. In the exemplary embodiment, components of computer system 100 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular telecommunications connection (e.g., a 3G, 4G, 5G, etc., connection), a cable modem, and a BLUETOOTH connection.

Computer system 100 also includes one or more database(s) 116 containing information on a variety of matters. For example, database 116 may include such information as telematics data, sensor data, user profiles, and/or any other information used, received, and/or generated by computer system 100 and/or any component thereof, including such information as described herein. In one exemplary embodiment, database 116 may include a cloud storage device, such that information stored thereon may be securely stored but still accessed by one or more components of computer system 100, such as, for example, user analytics computing device 110, in-vehicle computing devices 104, user computing devices 108, and/or insurance servers 114. In one embodiment, database 116 may be stored on user analytics computing device 110. In any alternative embodiment, database 116 may be stored remotely from user analytics computing device 110 and may be non-centralized.

Computer system 100 includes at least one vehicle 102 registered therewith, where each vehicle 102 is associated with at least one respective driver user and has an insurance policy associated therewith (e.g., where insurance policies maintained by insurance server 114). In the exemplary embodiment, each vehicle 102 includes a communication device 106 such that the vehicle 102 may communicate with user analytics computing device 110, for example, via the Internet, to receive instructions and/or transmit telematics data, sensor data, and/or other information. Vehicle 102 may additionally communicate with other components of computer system 100, such as database 116, user computing device(s) 108, insurance server 114, etc. Vehicles 102 may be configured to capture and/or generate telematics and/or sensor data during operation thereof (whether the vehicles are autonomous, semi-autonomous, and/or manually driven). Specifically, vehicles 102 have one or more sensors disposed thereon, such as location sensors, audio sensors, video sensors, cameras, LIDAR, RADAR, GPS/navigation systems, acceleration/deceleration sensors, braking sensors, turning sensors, scanners, and/or any other sensor, including those described elsewhere herein.

The sensors operate and collect and/or generate telematics and/or sensor data passively and/or actively as the vehicle 102 operates. The sensors may detect, for example, conditions of vehicle 102, such as speed, acceleration, gear, braking, and other conditions related to the operation of vehicle 102, for example: at least one of a measurement of at least one of speed, direction, rate of acceleration, rate of deceleration, location, position, orientation, and rotation of the vehicle, and a measurement of one or more changes to at least one of speed, direction, rate of acceleration, rate of deceleration, location, position, orientation, and rotation of the vehicle. User analytics computing device 110 may receive any such data from vehicles 102 (e.g., via in-vehicle computing device 104 and communication device 106).

In some embodiments, user computing devices 108 may be computers that include a web browser or a software application to enable user computing devices 108 to access the functionality of user analytics computing device 110 using the Internet or a direct connection, such as a cellular network connection. User computing devices 108 may be any device capable of accessing the Internet including, but not limited to, a desktop computer, a mobile device (e.g., a laptop computer, a personal digital assistant (PDA), a cellular phone, a smartphone, a tablet, a phablet, netbook, notebook, smart watches or bracelets, smart glasses, wearable electronics, pagers, virtual reality headsets, augmented reality glasses, voice or chat bots, wearables, etc.), or other web-based connectable equipment.

Each user computing device 108 may be associated with a particular user, which may include an insured associated with an insurance policy offered by insurance server 114. User computing devices 108 may be used to access a data management app (e.g., a telematics collection app, insurance app, and/or game app) 120 maintained by user analytics computing device 110, for example, via a user interface 122 when data management app 120 is executed on user computing device 108. A user may use data management app 120 to provide inputs to user analytics computing device 110, change preferences (e.g., provide permission for user analytics computing device 110 to receive telematics data), receive user offerings, view insurance policy information, and perform other actions, including those described elsewhere herein.

User computing devices 108 may be configured to capture and/or generate telematics and/or sensor data during operation thereof (e.g., while the user computing device 108 is on or active and/or in motion). More particularly, Additionally, or alternatively, user computing devices 108 have one or more sensors disposed thereon, such as location sensors, audio sensors, video sensors, cameras, GPS/navigation systems, accelerometers, gyroscopes, scanners, and/or any other sensor, including those described elsewhere herein. The sensors operate and collect and/or generate telematics and/or sensor data passively and/or actively as user computing device 108 is operating. In some embodiments, the sensor data includes information captured about the respective device's motion. User analytics computing device 110 may receive any such data from user computing devices 108.

User analytics computing device 110 may be configured to process telematics data and/or sensor data received from vehicles 102 and/or user computing devices 108, and/or data received from third-party devices 112, to determine whether a user's mobile device is on DND mode while the user is driving and to generate a distraction profile for the user. More particularly, user analytics computing device 110 determines whether a user is driving during a trip and whether a user's mobile device is in DND mode while the user is driving. Based upon this information, user analytics computing device 110 generates a distraction profile for the user detailing how often the user's mobile device is in DND mode while the user is driving. User analytics computing device 110 may collect DND mode data while user is driving over time to build the user's distraction profile.

User analytics computing device 110 may use one or more techniques for determining whether a user is driving. For example, in some embodiments, user analytics computing device 110 may determine the vehicle is in motion using telematics data from telematics data and/or sensor data received from vehicle 102 and/or user computing devices 108. User analytics computing device 110 may further use telematics data and/or sensor data received from vehicle 102 and/or user computing device 108 to determine whether a user is in the driver's seat. For example, user analytics device 110 may determine whether a current driver seat position is consistent with driver seat positions historically associated with the user.

Additionally, or alternatively, user analytics device 110 may use location data to determine whether a location of the user's mobile device is associated with the driver's seat. Additionally, or alternatively, user analytics device 110 transmits a message to user computing device 108 when the user is within a predefined distance of vehicle 102 asking whether the user will be driving and use the user's response when determining whether the user is the driver during a trip.

Additionally, or alternatively, user analytics computing device 110 leverages a user's driving profile, generated by user analytics computing device 110 or another computing device, to determine whether a user is driving. As used herein, a user's “driving profile” is a summary, aggregation, and/or general description of a user's driving behavior. The driving profile may therefore include data associated with how the user drives (e.g., speed, acceleration, braking, cornering, following distance), where the user drives (e.g., “common” routes), when the user drives (e.g., “common” commute times), and the like. The driving profile may include average values, maximum values, minimum values, weight averages, median values, ranges, and other quantitative measures of the user's driving behavior. The driving profile may also include non-quantitative elements, such as a user's typical locations, routes, and the like. Therefore, user analytics computing device 110 may compare current telematics data to a user's driving profile to determine whether a user is driving.

User analytics computing device 110 may then generate user-specific user offerings, such as recommendations, incentives, and the like, to affect or influence user behavior (e.g., to reduce distracted driving, etc.).

Third party devices 112 may be computing devices associated with external sources of data. User analytics computing device 110 may request, receive, and/or otherwise access data from third party devices 112. Third party devices 112 may be any devices capable of interconnecting to the Internet, including a server computing device, a mobile computing device or “mobile device,” such as a smartphone, or other web-connectable equipment or mobile devices.

Insurance server 114 may be associated with and/or maintained by an insurance provider, which provides insurance policies associated with vehicles 102, vehicle users, and the like. Insurance server 114 may communicate with user analytics computing device 110, vehicles 102, user computing device(s) 108, and/or database 116 in order to transmit and/or receive information associated with the insurance policies. For example, insurance server 114 may transmit insurance policies to user analytics computing device 110, and/or may receive or access user profiles, user offerings, responses to user offerings, and the like.

### Exemplary User Analytics Computing Device

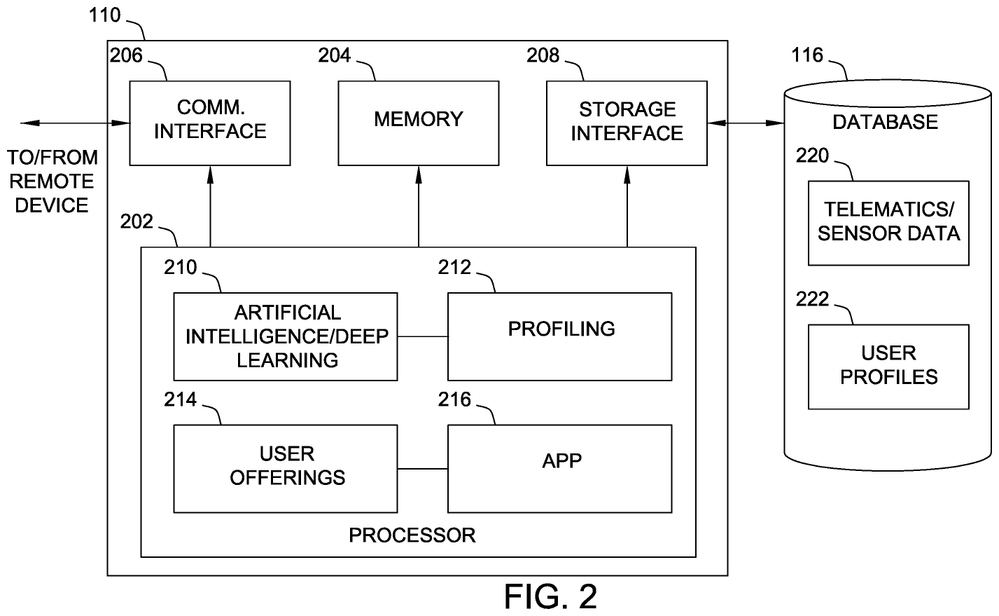

FIG. 2 depicts a user analytics computing device 110 (as shown in FIG. 1), according to an embodiment. In some embodiments, user analytics computing device 110 may include a processor 202, a memory 204 (which may be similar to database 116, also shown in FIG. 1), a communication interface 206, and a storage interface 208. Processor 202 is configured to execute instructions, which may be stored in memory 204. Processor 202 includes one or more processing units (e.g., in a multi-core configuration) and may be configured to execute a plurality of modules.

In some embodiments, processor 202 is operable to execute an artificial intelligence/deep learning (AI/DL) module 210, a profiling module 212, a user offerings module 214, and a module 216 that maintains functionality for data management app 120 (shown in FIG. 1). Modules 210, 212, 214, and 216 may include specialized instruction sets, and/or coprocessors. Database 116 and/or memory 204 may store any data and/or instructions necessary for modules 210, 212, 214, and 216 to function as described herein. In the exemplary embodiment, database 116 may store telematics and/or sensor data 220 and/or user profiles 222.

AI/DL module 210 may execute artificial intelligence and/or deep learning functionality on behalf of profiling module 212. Specifically, AI/DL module 210 may include any rules, algorithms, training data sets/programs, and/or any other suitable data and/or executable instructions that enable user analytics computing device 110 employ artificial intelligence and/or deep learning to determine when a user is driving, generate user profiles 222, user offerings, and the like.

Profiling module 212 may create one or more user profiles 222, such as a distraction profile, that represent user behavior, which may be leveraged (e.g., by user offerings module 214) to generate user offerings for one or more user responsive to those users' telematics data. For example, profiling module 212 may access and process telematics data and/or sensor data 220 received from a user computing device 108 and/or a vehicle 102 to determine how often a user's mobile device was in DND mode while the user was driving and generate a distraction profile with this information, as described here.

For example, distraction profile may include is a summary, aggregation, and/or general description of a status of a user's mobile device while driving, over a period of time. Profiling module 212 may generate and develop the distraction profile using telematics data and/or sensor data 220. More particularly, user analytics computing device 110 determines whether a user is driving during a trip and whether a user's mobile device is in DND mode while the user is driving. Based upon this information, user analytics computing device 110 generates a distraction profile for the user detailing how often the user's mobile device is in DND mode while the user is driving. User analytics computing device 110 may collect DND mode data while user is driving over time to build the user's distraction profile.

Profiling module 212 may be configured to employ AI/DL module 210 to identify patterns and/or trends, for example, in telematics/sensor data 220 to determine whether a user's mobile device is in DND mode while the user is driving and/or to generate a user offering. In particular, profiling module 323 may employ AI/DL module 210 to train a machine learning module using the user's driving settings and/or driving behavior over a period of time (e.g., one week, two weeks, one month, etc.) such that an operator model learns settings and/or behaviors that are commonly associated with a user. For instance, AI/DL module 210 may identify driver seat position, user location, vehicle speed, vehicle location, travel mode, and/or trends and/or patterns associated with a user. In some embodiments, AI/DL module 210 generates, e.g., trains, the operator model using a training dataset that includes one or more training variables (e.g., seat position, user location, vehicle speed, vehicle location, travel mode, and the like). The training dataset may include the historic data or a subset of the historical data. AI/DL module 210 may update the training dataset by creating one or more new historical records. Subsequently, the AI/DL module 210 may re-train the operator model using the updated training dataset, further improving the accuracy of the operator model

Profiling module 212 may employ AI/DL module 210 to use the trained operator model to determine whether a user is driving. Profiling module 212 may use the output from the trained operator model to identify whether a user is driving. If profiling module 212 determines the user is driving, profiling module 212 monitors whether the user's mobile device is in DND mode while the telematics data indicates the mobile device is in motion. Profiling module incorporates such information into the user's distraction profile 222. The user's distraction profile 222 may be viewable via data management app 120, as described in more detail below.

User offerings module 214 may generate user offerings, such as incentives based upon a user's distraction profile 222. For example, user offerings module 214 may generate a discount or reduction in the user's insurance premium. More particularly, a user may receive a discount or reduction in their insurance premium based upon how frequently their mobile device is on DND mode while the user is driving. Accordingly, the user may reduce their overall risk (e.g., by driving with their mobile device in DND mode) and save money (e.g., by receiving the inventive).

In some embodiments, user offerings module 214 generates the user offering based upon historical data. More particularly, user offerings module 214 generates the user offering based upon the user's mobile device mode data over a time period (e.g., one week, two weeks, a month, six months, etc.). For example, in some embodiments, user offering module 214 generates a user offering comprising an insurance discount based upon the percentage of time the user has driven with their mobile device in DND mode. For another example, if the user drove with their mobile device in DND mode 80% of the time over the past month, the user offering module 214 may generate a user offering of a 20% insurance discount for the next month; if the user drove with their mobile device in DND mode 70% of the time over the past month, the user offering module 214 may generate a user offering of a 10% insurance discount for the next month; if the user drove with their mobile device in DND mode 60% of the time, the user offering module 214 may generate a user offering of a 5% insurance discount for the next month. These numerical figures are provided by way of example only, and various other discounts may be generated based upon the user's distraction profile data.

In some embodiments, the user offering is transmitted to insurance server 114 via communication interface 206 and insurance server 114 may be configured to automatically apply the discount or offer. Additionally, or alternatively, the user offering may receive a numerical code, a QR code, a barcode, or the like, which the user can use to manually apply a discount.

User offerings module 214 may transmit the user offering to the user within data management app 120. Additionally, or alternatively, user offerings module 214 transmits the user offering to the user as a pop-up or push-notification, through a text message, e-mail, and/or the like. The user offering may be presented to the user as a report or document that includes the notification. In some embodiments, the user offering may be presented to the user as a report or document.

Additionally, or alternatively, user offerings module 214 may generate and/or transmit user offerings in real-time, that is, based upon the user's current mobile phone mode during a trip. In some embodiments, user offerings module 214 may transmit the user offering to the user in the form of alerts (e.g., within the data management app 120, as a text message or a pop-up or push notification, etc.). The alerts may identify the current mode of the user's mobile device and may include a recommendation (e.g., “turn DND mode on”, “keep mobile device in DND mode for entire trip”, etc.). Additionally, or alternatively, the alert may include an incentive, which may be a monetary incentive (e.g., “turn DND mode on to receive a discount on your insurance premium”). In some embodiments, the alert is transmitted before the user begins driving (e.g., as the user approaches their vehicle) or during the trip (e.g., while the user is stopped at a stop light). In some embodiments, the alert further includes a mechanism for changing a mode of the mobile device. For example, in some embodiments, the alert includes a toggle in which the user can switch their mobile device into DND mode.

App module 216 is configured to facilitate maintaining data management app 120 and providing the functionality thereof to users. App module 216 may store instructions that enable the download and/or execution of data management app 120 at user computing devices 108. App module 216 may store instructions regarding user interfaces, controls, commands, settings, and the like, and may format data, such as user profiles, user offerings, eligibility conditions, and the like, into a formal suitable for transmitting to user computing devices 108 for display thereof.

In some embodiments, processor 202 is operatively coupled to communication interface 206 such that user analytics computing device 110 is capable of communicating with remote device(s) such as vehicles 102, user computing devices 108, third party devices 112, and/or insurance servers 114 (all shown in FIG. 1) over a wired or wireless connection. For example, communication interface 206 may receive telematics, sensor, and/or other data from user computing devices 108, vehicles 102, and/or third-party devices 112. Communication interface 206 may include, for example, a wired or wireless network adapter and/or a wireless data transceiver for use with a mobile telecommunications network.

Processor 202 may also be operatively coupled to database 116 (and/or any other storage device) via storage interface 208. Database 116 may be any computer-operated hardware suitable for storing and/or retrieving data. In some embodiments, database 116 may be integrated in user analytics computing device 110. For example, user analytics computing device 110 may include one or more hard disk drives as database 116. In other embodiments, database 116 is external to user analytics computing device 110 and is accessed by a plurality of computer devices. For example, database 116 may include a storage area network (SAN), a network attached storage (NAS) system, multiple storage units such as hard disks and/or solid-state disks in a redundant array of inexpensive disks (RAID) configuration, cloud storage devices, and/or any other suitable storage device.

Storage interface 208 may be any component capable of providing processor 202 with access to database 116. Storage interface 208 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to database 116.

Processor 202 may execute computer-executable instructions for implementing aspects of the disclosure. In some embodiments, processor 202 may be transformed into a special purpose microprocessor by executing computer-executable instructions or by otherwise being programmed. For example, processor 202 may be programmed with the instructions such as those illustrated in FIG. 8.

Memory 204 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

### Exemplary Data Management App

In some embodiments, user analytics computing device 110 may also maintain data management software application or “app” 120 (also referred to as user analytics app herein) which enables users to track various metrics associated with their behavior (e.g., driving profiles, travel modes used, etc.), adjust user settings, and access a plurality of services associated with computer system 100, including receiving and responding to user offerings. Data management app 120 may be executed on user computing devices 108 and/or in-vehicle computing devices 104, as described elsewhere herein.

In one embodiment, data management app 120 enables a user to view telematics data, sensor data, and/or additional or alternative data collected by their vehicle 102 and/or user computing device 108 that is transmitted to user analytics computing device 110. Data management app 120 may further enable the vehicle user to adjust one or more settings, such as user preferences associated with what data is transmitted and/or how often data is transmitted. Data management app 120 may also enable a user to sync profiles or data transmission with other services or apps on their device(s), such as ride-sharing apps, vehicle-rental apps, and the like.

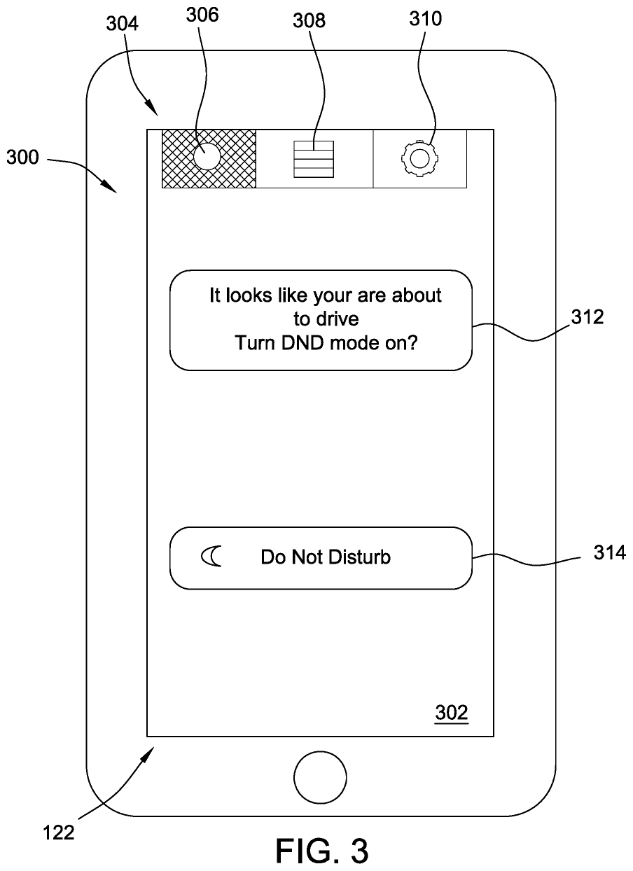

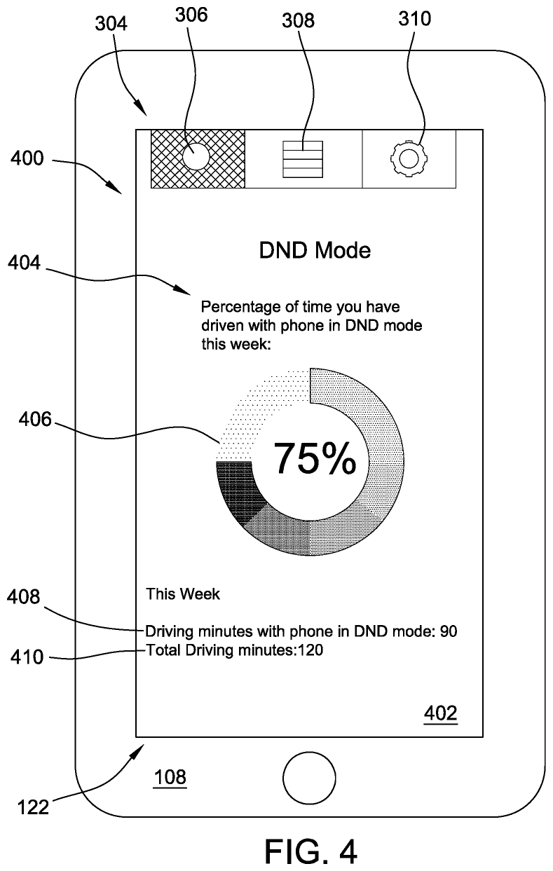

FIGS. 3 and 4 depict exemplary screen captures or “screenshots” of user interface 122 of data management app 120 as executed on a user computing device 108 (all shown in FIG. 1). The example screenshots include various features and functionalities of data management app 120. In particular, user analytics computing device 110 causes to be displayed at least user offerings at user computing device 108, specifically via data management app 120.

More specifically, FIG. 3 depicts a screenshot 300 of a first page 302 within user interface 122 of data management app 120. First page 302 may display a menu 304 of icons that may be selected by the user to access different sections, pages, and/or functionality of data management app 120. In the illustrated embodiment, menu 304 includes a first icon 306 associated with a main screen (represented as a circle), a second icon 308 associated with a user distraction profile screen (represented as a lined box), and a third icon 310 associated with settings (represented as a gear). It should be readily understood that menu 304 may include additional, fewer, and/or alternative icons that may represent additional, fewer, and/or alternative sections, pages, and/or functionality within data management app 120.

In the illustrated embodiment, the user has selected icon 306 associated with the Main Screen to display first page 302. First page 302 may display one or more statuses or notifications. In the illustrated example, a pop-up or push notification 312 appears querying the user whether they would like to turn DND mode on. This pop-up or push notification may appear in response to the user analytics computing device determine the user's mobile device is within a distance of the vehicle (e.g., using a wireless beacon location within the vehicle, GPS, and the like) or some other indication that user may be driving soon.

In some embodiments, the status and/or notification may comprise a status of the mobile device, an incentive, and/or a user offering related to the status of the mobile device. For example, the notification may include a recommendation that the user put their phone in DND mode, and an indicate that the user will save money by doing so. In the illustrated example, notification 312 is accompanied by a toggle 314 in which the user can switch their mobile device into DND mode. Additionally, or alternatively, first page 302 may display a prompt asking the user to confirm whether the user is the driver during a particular trip.

FIG. 4 depicts a screenshot 400 of a second page 402 accessed by a user within user interface 122 of data management app 120. In the illustrated embodiment, the user has selected the icon 308 associated with the user distraction profile screen to display second page 402. User interface 122 displays DND mode data associated with a user. The user's profile is a summary, aggregation, and/or general description of a mode of a user's mobile device while driving. More particularly, the user's profile may comprise a summary 404 of how often a user's mobile device is in DND mode while driving. The user analytics computing device may develop or generate the user's profile over time, based upon telematics data associated with one or more trips the user has taken in which the user was the driver. The profile may include average values, maximum values, minimum values, weight averages, median values, ranges, and other quantitative measures of the mode of the user's mobile device while driving. In this example, user interface 122 displays a graph 406 illustrating the percentage of time the user has driven with their phone in DND mode over the past week and displays the user's driving minutes 408 with their phone in DND mode and the user's total driving minutes 410.

Based upon the user's profile, the user analytics computing device may generate one or more user offerings. In some embodiments, the one or more offerings may comprise a reduction in the user's insurance premium or an associated discount. The user analytics computing device may transmit the user offering to the user within the data management app 120. In some embodiments, data management app 120 may notify the user of the user offering through a pop-up or push notification, a text message, or the like. The data management app 120 may display the user offering to the user as a report or document.

### Exemplary User Computer Device

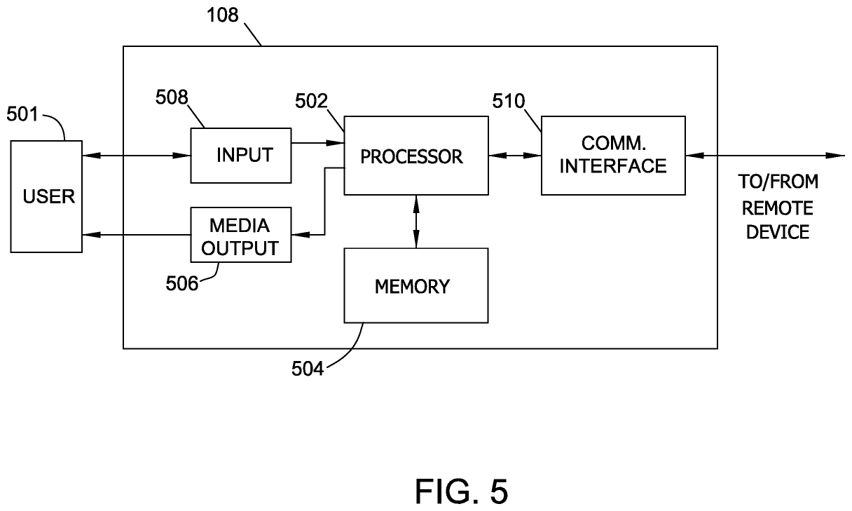

FIG. 5 depicts an exemplary configuration of an exemplary user computer device 108 that may be used with computer system 100 (shown in FIG. 1), in accordance with one embodiment of the present disclosure. User computer device 108 may be operated by a user 501.

User computer device 108 may include a processor 502 for executing instructions. In some embodiments, executable instructions may be stored in a memory area 504. Processor 502 may include one or more processing units (e.g., in a multi-core configuration). Memory area 504 may be any device allowing information such as executable instructions and/or transaction data to be stored and retrieved. Memory area 504 may include one or more computer-readable media. Memory area 804 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

User computer device 108 also may include at least one media output component 506 for presenting information to user 501, such as user interface 122 of data management app 120 (both shown in FIG. 1) when data management app 120 is executed on user computing device 108. Media output component 506 may be any component capable of conveying information to user 801. In some embodiments, media output component 506 may include an output adapter (not shown), such as a video adapter and/or an audio adapter. An output adapter may be operatively coupled to processor 502 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones)).

In some embodiments, user computer device 108 may include an input device 508 for receiving input from user 501. User 501 may use input device 508 to, without limitation, interact with user analytics computing device 110 (both in FIG. 1), receive user offerings, and the like. Input device 508 may include, for example, a keyboard, a pointing device, a mouse, a stylus, and/or a touch sensitive panel (e.g., a touch pad or a touch screen). A single component such as a touch screen may function as both an output device of media output component 506 and input device 508.

User computer device 108 may also include a communication interface 510, communicatively coupled to a remote device such as user analytics computing device 110. For example, user analytics computing device 110 obtains the DND mode data of user computing device 108 via communication interface 510. Communication interface 510 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 504 may be, for example, computer-readable instructions for providing a user interface to user 501 via media output component 506 and, optionally, receiving and processing input from input device 508. The user interface may include, among other possibilities, a web browser and/or a client application. Web browsers enable users, such as user 501, to display and interact with media and other information typically embedded on a web page or a website from user analytics computing device 110. A client application (e.g., data management app 120) may allow user 501 to interact with, for example, user analytics computing device 110. For example, instructions may be stored by a cloud service and the output of the execution of the instructions sent to the media output component 506.

### Exemplary Computer Device

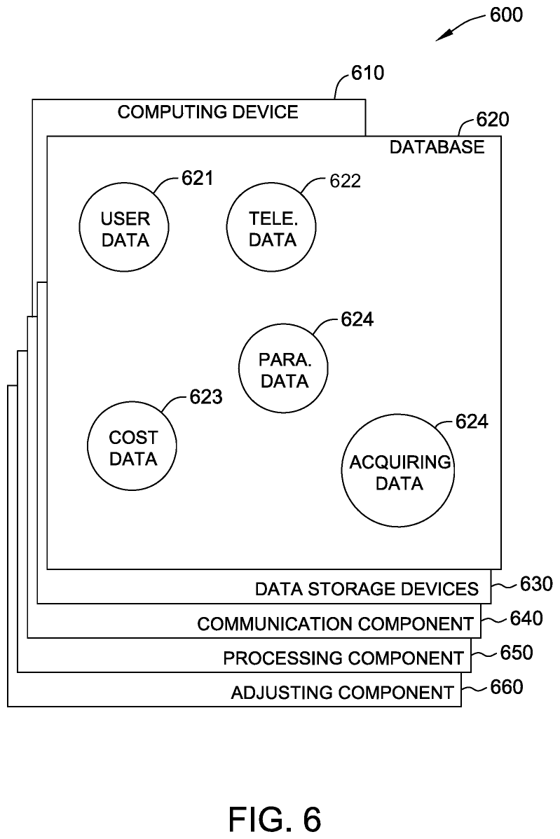

FIG. 6 depicts a diagram 600 of components of one or more exemplary computing devices that may be used in system 100 (shown in FIG. 1). Database 620 may be coupled with several separate components within computing device 610, which perform specific tasks. In this embodiment, database 620 may include user data 621 (e.g., historical driving data including historical telematics data and historical insurance claim data, user information including age, gender, and location, and group data), telematics data 622 (e.g., current and/or historical telematics data of users, including acceleration, braking, cornering, speed, miles, and location information), cost data 623 (e.g., costs associated with procuring the vehicle and acquisition costs), parameter data 624 (e.g., parameters associated with the acquiring cost), and acquiring data 625 (e.g., acquiring cost data and the parameters associated with the acquiring cost). In some embodiments, database 620 is similar to database 116 (shown in FIG. 1).

Computing device 610 may include database 620, as well as a data storage device 630. Computing device 610 may also include a communication component 640 for transmitting and receiving data between in-vehicle computing device 104, user computing device 108, and third-party devices 112 (shown in FIG. 1). Computing device 610 may further include a processing component 650 that may, for example, process telematics data (e.g., received from user computing device 108) and processing the acquiring cost. An adjustment component 660 may assist with adjusting parameters and acquisition cost.

### Exemplary Computer-Implemented Method for Processing Vehicle-Based Telematics Data and Generating User Offerings Responsive to the Vehicle-Based Telematics Data

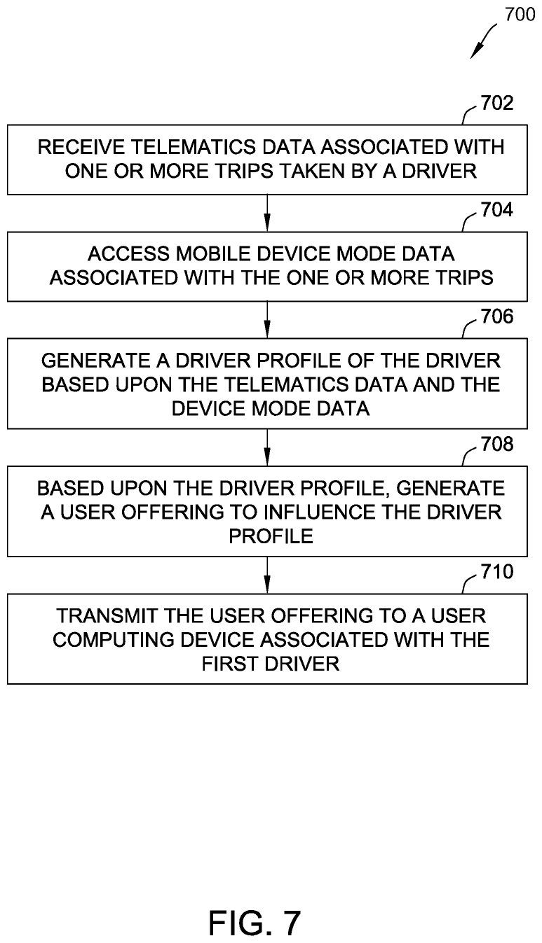

FIG. 7 depicts a flow chart of an exemplary computer-implemented method 700 for processing vehicle-based telematics data and generating user offerings responsive to the vehicle-based telematics data, using computer system 100 shown in FIG. 1. In the exemplary embodiment, method 700 may be performed by user analytics computing device 110 (shown in FIG. 1).

Method 700 may include receiving 702, from a vehicle computing device (e.g., vehicle computing device 104) associated with a first vehicle (e.g., vehicle 102, both shown in FIG. 1), telematics data associated with one or more of trips taken by a driver using the first vehicle. Method 700 may further comprise confirming the driver is, in fact, the driver, through the telematics data, sensor data, additional data, and/or data provided by the driver (e.g., confirmation from the driver through user computing device 108).

Method 700 may further include accessing 704 device mode data associated with the one or more trips, and generating 706 a driver profile of the driver based upon the telematics data and the device mode data. The device mode data, the telematics data, sensor data, and/or additional data may be input into a trained operator model to determine whether the user is driving and/or whether the user's mobile device was in DND mode during all or a portion of the trip.

Additionally, method 700 may include, based upon the driver profile, generating 708 a user offering to influence the driver profile, and transmitting 710 the user offering to a user computing device (e.g., user computing device 108, shown in FIG. 1) associated with the driver.

Method 700 may include additional, fewer, and/or alternative steps, including those described herein. For example, in some embodiments, the user analytics computing device to send one or more messages to the user's mobile device. For example, in response to the user analytics computing device determine the user's mobile device is within a distance of the vehicle (e.g., using a wireless beacon location within the vehicle, GPS, or the like), the user analytics computing device may send a message to the user's computing device, such as “Would you like to turn Do Not Disturb mode on?” in order to remind a user to turn on a DND mode before driving. In some embodiments, the message may further comprise a toggle in which a user can switch the mobile device to DND mode.

### Other Exemplary Embodiments

In one embodiment, a user analytics computing device for processing mobile device telematics data and generating user offerings responsive to the mobile device telematics data is provided. The user analytics computing device includes at least one processor in communication with a memory device, the at least one processor programmed to: (i) generate an operator model for a user based upon historical telematics data, an output of the operator model to determine whether the user is operating a vehicle; (ii) receive, from a mobile device of the user, telematics data associated with movement of the user over a period of time and mobile device mode data over the period of time; (iii) input the telematics data into the operator model, and in response to determining the user is operating the vehicle, generate a driver profile based upon the telematics data and the device mode data; (iv) generate, based upon the driver profile, a user offering; and (v) transmit, to the mobile device of the user, the user offering.

In another embodiment, the user analytics computing device of above further includes the operator model being configured to determine whether the device of the user is in do not disturb mode.

In another embodiment, the user analytics computing device of above further includes the telematics data is first telematics data, the mobile device mode data is first mobile device mode data and the period of time is a first period of time, and wherein at least one processor is further programmed to: receive, from a mobile device of the user, second telematics data associated with movement of the user over a second period of time and second mobile device mode data over the second period of time; and input the second telematics data into the operator model, and in response to determining the user is operating the vehicle, build upon the driver profile based upon the second telematics data and the second mobile device mode data.

In another embodiment, the user analytics computing device of above wherein the at least one processor is further programmed to train the operator model using a training dataset that includes one or more training variables, the training dataset comprising historical data.

In another embodiment, the user analytics computing device of above wherein the at least one processor is further programmed to update the training dataset to include new historical data and re-train the trained operator model using the updated training set.

In another embodiment, the user analytics computing device of above wherein the at least one processor is further programmed to, in response to determining the device of the user is within a predetermined distance of a vehicle, cause to be displayed on the user computing device, a notification to turn the device into a do not disturb mode before driving.

In another embodiment, the user analytics computing device of above further includes the notification being a pop-up or push-notification.

In another embodiment, the user analytics computing device of above further includes the user offering being generated based upon real-time data.

The exemplary embodiments of the user analytics computing device may include any combinations of the embodiments described above.

In another embodiment, a computer-implemented method for processing vehicle-based telematics data and generating user offerings responsive to the vehicle-based telematics data is provided. The method includes (i) generating an operator model for a user based upon historical telematics data, an output of the operator model to determine whether the user is operating a vehicle; (ii) receiving, from a mobile device of the user, telematics data associated with movement of the user over a period of time and mobile device mode data over the period of time; (iii) inputting the telematics data into the operator model, and in response to determining the user is operating the vehicle, generate a driver profile based upon the telematics data and the device mode data; (iv) generating, based upon the driver profile, a user offering; and (v) transmitting, to the mobile device of the user, the user offering.

In another embodiment, the computer-implemented method of above further includes the operator model being configured to determine whether the device of the user is in do not disturb mode.

In another embodiment, the computer-implemented method of above further includes the telematics data being first telematics data, the mobile device mode data being first mobile device mode data and the period of time being a first period of time, and the method further comprises: receiving, from a mobile device of the user, second telematics data associated with movement of the user over a second period of time and second mobile device mode data over the second period of time; and inputting the second telematics data into the operator model, and in response to determining the user is operating the vehicle, building upon the driver profile based upon the second telematics data and the second mobile device mode data.

In another embodiment, the computer-implemented method of above further comprising training the operator model using a training dataset that includes one or more training variables, the training dataset comprising historical data.

In another embodiment, the computer-implemented method of above further includes updating the training dataset to include new historical data and re-training the trained operator model using the updated training set.

In another embodiment, the computer-implemented method of above further includes, in response to determining the device of the user is within a predetermined distance of a vehicle, causing to be displayed on the user computing device, a notification to turn the device into a do not disturb mode before driving.

In another embodiment, the computer-implemented method of above wherein the notification is a pop-up or push-notification.

In another embodiment, the computer-implemented method of above wherein the user offering is generated based upon real-time data.

The exemplary embodiments of the computer-implemented method may include any combinations of the embodiments described above.

In another embodiment, a non-transitory computer-readable storage medium having computer-executable instructions embodied thereon is provided. When executed by a user analytics computing device having at least one processor in communication with at least one memory, the computer-executable instructions cause the at least one processor to: (i) generate an operator model for a user based upon historical telematics data, an output of the operator model to determine whether the user is operating a vehicle; (ii) receive, from a mobile device of the user, telematics data associated with movement of the user over a period of time and mobile device mode data over the period of time; (iii) input the telematics data into the operator model, and in response to determining the user is operating the vehicle, generate a driver profile based upon the telematics data and the device mode data; (iv) generate, based upon the driver profile, a user offering; and (v) transmit, to the mobile device of the user, the user offering.

In another embodiment, the computer-executable instructions embodied on the non-transitory computer-readable storage medium of above wherein the operator model is configured to determine whether the device of the user is in do not disturb mode.

In another embodiment, the computer-executable instructions embodied on the non-transitory computer-readable storage medium of above wherein the telematics data is first telematics data, the mobile device mode data is first mobile device mode data and the period of time is a first period of time, and wherein the computer-executable instructions further cause the at least one processor to: receive, from a mobile device of the user, second telematics data associated with movement of the user over a second period of time and second mobile device mode data over the second period of time; and input the second telematics data into the operator model, and in response to determining the user is operating the vehicle, build upon the driver profile based upon the second telematics data and the second mobile device mode data.

In another embodiment, the computer-executable instructions embodied on the non-transitory computer-readable storage medium of above wherein the computer-executable instructions further cause the at least one processor to train the operator model using a training dataset that includes one or more training variables, the training dataset comprising historical data.

The exemplary embodiments of the computer-executable instructions may include any combinations of the embodiments described above.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, historical estimates, and/or actual repair costs. The machine learning programs may utilize deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing-either individually or in combination. The machine learning programs may also include natural language processing, semantic analysis, automatic reasoning, and/or machine learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the object, vehicle, user, damage, needed repairs, costs and/or incident from vehicle data, insurance policies, geolocation data, image data, and/or other data.

Based upon these analyses, the processing element may learn how to identify characteristics and patterns that may then be applied to analyzing image data, model data, and/or other data. For example, the processing element may learn, with the user's permission or affirmative consent, to identify the type of incident that occurred based upon images of the resulting damage. The processing element may also learn how to identify damage that may not be readily visible based upon the received image data.

In some embodiments, the voice bots or chatbots discussed herein may be configured to utilize ML and/or AI techniques. For instance, the voice bot or chatbot may be a ChatGPT chatbot. The voice bot or chatbot may employ supervised or unsupervised machine learning techniques, which may be followed by, and/or used in conjunction with, reinforced or reinforcement learning techniques. The voice bot or chatbot may employ the techniques utilized for ChatGPT.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), SD card, memory device and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A user analytics computing device for processing mobile device telematics data and generating user offerings responsive to the mobile device telematics data, the user analytics computing device comprising at least one processor in communication with a memory device, the at least one processor programmed to:
generate an operator model for a user based upon historical telematics data, an output of the operator model to determine whether the user is operating a vehicle;
receive, from a mobile device of the user, telematics data associated with movement of the user over a period of time and mobile device mode data over the period of time;
input the telematics data into the operator model, and in response to determining the user is operating the vehicle, generate a driver profile based upon the telematics data and the device mode data;
generate, based upon the driver profile, a user offering; and
transmit, to the mobile device of the user, the user offering.

2. The user analytics computing device of claim 1, wherein the operator model is configured to determine whether the device of the user is in do not disturb mode.

3. The user analytics computing device of claim 1, wherein the telematics data is first telematics data, the mobile device mode data is first mobile device mode data and the period of time is a first period of time, and wherein at least one processor is further programmed to:
receive, from a mobile device of the user, second telematics data associated with movement of the user over a second period of time and second mobile device mode data over the second period of time; and
input the second telematics data into the operator model, and in response to determining the user is operating the vehicle, build upon the driver profile based upon the second telematics data and the second mobile device mode data.

4. The user analytics computing device of claim 1, wherein the at least one processor is further programmed to train the operator model using a training dataset that includes one or more training variables, the training dataset comprising historical data.

5. The user analytics computing device of claim 4, wherein the at least one processor is further programmed to update the training dataset to include new historical data and re-train the trained operator model using the updated training set.

6. The user analytics computing device of claim 1, wherein the at least one processor is further programmed to, in response to determining the device of the user is within a predetermined distance of a vehicle, cause to be displayed on the user computing device, a notification to turn the device into a do not disturb mode before driving.

7. The user analytics device of claim 6, wherein the notification is a pop-up or push-notification.

8. The user analytics device of claim 1, wherein the user offering is generated based upon real-time data.

9. A computer-implemented method for processing vehicle-based telematics data and generating user offerings responsive to the vehicle-based telematics data, the method comprising:
generating an operator model for a user based upon historical telematics data, an output of the operator model to determine whether the user is operating a vehicle;
receiving, from a mobile device of the user, telematics data associated with movement of the user over a period of time and mobile device mode data over the period of time;
inputting the telematics data into the operator model, and in response to determining the user is operating the vehicle, generate a driver profile based upon the telematics data and the device mode data;
generating, based upon the driver profile, a user offering; and
transmitting, to the mobile device of the user, the user offering.

10. The computer-implemented method claim 9, wherein the operator model is configured to determine whether the device of the user is in do not disturb mode.

11. The computer-implemented method of claim 9, wherein the telematics data is first telematics data, the mobile device mode data is first mobile device mode data and the period of time is a first period of time, and the method further comprises:
receiving, from a mobile device of the user, second telematics data associated with movement of the user over a second period of time and second mobile device mode data over the second period of time; and
inputting the second telematics data into the operator model, and in response to determining the user is operating the vehicle, building upon the driver profile based upon the second telematics data and the second mobile device mode data.

12. The computer-implemented method of claim 9, the method further comprising training the operator model using a training dataset that includes one or more training variables, the training dataset comprising historical data.

13. The computer-implemented method of claim 12, the method further comprising updating the training dataset to include new historical data and re-training the trained operator model using the updated training set.

14. The computer-implemented method claim 9, the method further comprising, in response to determining the device of the user is within a predetermined distance of a vehicle, causing to be displayed on the user computing device, a notification to turn the device into a do not disturb mode before driving.

15. The computer-implemented method of claim 14, wherein the notification is a pop-up or push-notification.

16. The computer-implemented method of claim 9, wherein the user offering is generated based upon real-time data.

17. A non-transitory computer-readable storage medium having computer-executable instructions embodied thereon, when executed by a user analytics computing device having at least one processor in communication with at least one memory, the computer-executable instructions cause the at least one processor to:
generate an operator model for a user based upon historical telematics data, an output of the operator model to determine whether the user is operating a vehicle;
receive, from a mobile device of the user, telematics data associated with movement of the user over a period of time and mobile device mode data over the period of time;
input the telematics data into the operator model, and in response to determining the user is operating the vehicle, generate a driver profile based upon the telematics data and the device mode data;
generate, based upon the driver profile, a user offering; and
transmit, to the mobile device of the user, the user offering.

18. The non-transitory computer-readable storage medium of claim 17, wherein the operator model is configured to determine whether the device of the user is in do not disturb mode.

19. The non-transitory computer-readable storage medium of claim 17, wherein the telematics data is first telematics data, the mobile device mode data is first mobile device mode data and the period of time is a first period of time, and wherein the computer-executable instructions further cause the at least one processor to:
receive, from a mobile device of the user, second telematics data associated with movement of the user over a second period of time and second mobile device mode data over the second period of time; and
input the second telematics data into the operator model, and in response to determining the user is operating the vehicle, build upon the driver profile based upon the second telematics data and the second mobile device mode data.

20. The non-transitory computer-readable storage medium of claim 17, wherein the computer-executable instructions further cause the at least one processor to train the operator model using a training dataset that includes one or more training variables, the training dataset comprising historical data.
